(19) United States
(12) Patent Application Publication
(10) Pub. No.: US 2006/0182014 A1
(43) Pub. Date: Aug. 17, 2006

(54) Apparatus for and method of characterization of ethernet cable impairments

(75) Inventors: Italy Lusky, Hod Hasharon (IL); Daniel Wajcer, Beit-Yehoshua (IL); Naftali Sommer, Rishon Letzion (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/353,579

(22) Filed: Feb. 13, 2006

Related U.S. Application Data
(60) Provisional application No. 60/653,167, filed on Feb. 14, 2005.

(51) Int. Cl. H04J 3/10; H04L 12/26; H04J 1/16; H04J 1/12

(52) U.S. Cl. 370/201; 370/252; 370/241

(57) ABSTRACT

A novel mechanism for performing Ethernet noise source characterization including monitoring and analyzing several Ethernet impairments, including Ethernet 1000Base-T impairments. Time domain and frequency domain analysis techniques are used to characterize cable performance, supportable transmission rate and to determine whether cable performance and specification requirements are being met. Various noise sources are characterized including: echo signal, NEXT signal, FEXT signal, insertion loss, alien NEXT/external noise source and residual noise. Using time domain analysis, the power of the interfering signal is measured and compared to a pre-defined allowed reference limit. Alternatively, the filter tap values used in the receive signal processing blocks, e.g., echo canceller, NEXT canceller, FEXT detector/canceller, etc., can be used. In addition, the energy of the actual filtered output generated within the receiver from these processing blocks may be used as well. The measured or calculated results are checked to determine whether they are within compliance specified by the standard. Using frequency domain analysis, a Fourier transform is applied to the filter tap values or the output of the processing blocks themselves. The result is checked for compliance with the standard.

### REFERENCE TO PRIORITY APPLICATION

This application claims priority to U.S. Provisional Application Ser. No. 60/653,167, filed Feb. 14, 2005, entitled “Methods For Characterization Of Gigabit Ethernet Impairments,” incorporated herein by reference in its entirety.

### FIELD OF THE INVENTION

The present invention relates to the field of data communications and more particularly relates to an apparatus for and method of performing noise source characterization of high speed Ethernet PHY links (e.g., Gigabit Ethernet), including, for example, characterization of echo, near-end-crosstalk (NEXT) and far-end-crosstalk (FEXT), utilizing time and frequency domain analysis techniques.

### BACKGROUND OF THE INVENTION

Modern network communication systems are generally of either the wired or wireless type. Wireless networks enable communications between two or more nodes using any number of different techniques. Wireless networks rely on different technologies to transport information from one place to another. Several examples, include, for example, networks based on radio frequency (RF), infrared, optical, etc. Wired networks may be constructed using any of several existing technologies, including metallic twisted pair, coaxial, optical fiber, etc.

Communications in a wired network typically occurs between two communication transceivers over a length of cable making up the communications channel. Each communications transceiver comprises a transmitter and receiver components. A fault along the communication channel causes a disruption in communications between the transceivers. Typically, it is desirable to be able to determine when a fault occurs in the channel. Once a fault is detected, it is desirable to determine information about the fault, such as its location along the channel.

The deployment of faster and faster networks is increasing at an ever quickening pace. Currently, the world is experiencing a vast deployment of Gigabit Ethernet (GE) devices. As the number of installed gigabit Ethernet nodes increases, the need for reliable, comprehensive and user-friendly cable diagnostic tools has become more important than ever. The wide variety of cables, topologies and connectors deployed results in the need for non-intrusive identification and reporting of cable faults. It would be desirable to have a system capable of identifying and characterizing noise sources affecting a link and reporting these noise sources in the event the noise source exceeds a permitted envelope, as defined by the relevant standards.

The ability to gather diagnostics on the cable is particularly useful in the case where physical access to the cable is extremely difficult or impossible. Further, it is desirable to have the cable diagnostics capabilities built into the communications transceiver without requiring significant modification to existing transceivers.

Thus, there is a need for a mechanism for identifying and characterizing noise sources present in a communications link such as an Ethernet connection that can be incorporated into a conventional communications transceiver without requiring extensive modifications to the transceiver.

### SUMMARY OF THE INVENTION

The present invention is a novel mechanism for performing Ethernet noise source characterization including monitoring and analyzing several Ethernet impairments, including Ethernet 1000Base-T impairments. Time domain and frequency domain analysis techniques are used to characterize cable performance, supportable transmission rate and to determine whether cable performance and specification requirements are being met.

Various noise sources are characterized including: echo signal, NEXT signal, FEXT signal, insertion loss, alien NEXT/external noise source and residual noise. Using time domain analysis, the power of the interfering signal is measured and compared to a pre-defined allowed reference limit. Alternatively, the filter tap values used in the receive signal processing blocks, e.g., echo canceller, NEXT canceller, FEXT detector/canceller, etc., can be used. In addition, the energy of the actual filtered output generated within the receiver from these processing blocks may be used as well. The measured or calculated results are checked to determine whether they are within compliance specified by the standard. Using frequency domain analysis, a Fourier transform is applied to the filter tap values or the output of the processing blocks themselves. The result is checked for compliance with the standard.

Although the mechanism of the present invention can be used in numerous types of communication networks, it is intended that a common usage of the noise source characterization mechanism is with metallic paired cable such as typically used in Ethernet networks, e.g., CAT5, CAT5E, CAT6, etc.

The noise source characterization mechanism of the present invention the advantage of reuse of hardware components already available on conventional transceivers for characterization of echo, NEXT, FEXT, etc. noise thus simplifying the implementation of the invention.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is therefore provided in accordance with the invention, a method of characterizing communications cable impairments, the method comprising the steps of receiving one or more interfering signals over the cable, for each interfering signal, processing the interfering signal to yield a characterization therefrom and identifying unacceptable conditions on the cable by comparing the characterization to a reference.

There is also provided in accordance with the invention, an apparatus for characterizing communications cable impairments comprising means for receiving one or more interfering signals over the cable, means for processing each interfering signal to yield a characterization therefrom and means for identifying unacceptable conditions on the cable by comparing the characterization to a reference.

There is further provided in accordance with the invention, a communications transceiver coupled to a communications channel comprising a transmitter coupled to the communications channel, a receiver coupled to the communications channel, a noise source characterization module coupled to the transmitter and receiver, the noise source characterization module for characterizing communications cable impairments, comprising, means for receiving one or more interfering signals over the cable, means for processing each interfering signal to yield a characterization therefrom and means for identifying unacceptable conditions on the cable by comparing the characterization to a reference.

There is also provided in accordance with the invention, a communications transceiver coupled to a communications channel comprising a transmitter coupled to the communications channel, a receiver coupled to the communications channel, a noise source characterization module coupled to the transmitter and receiver, the noise source characterization module for characterizing communications cable impairments, comprising, means for receiving one or more interfering signals over the cable, means for performing time domain analysis on the one or more interfering signals to yield time domain characterizations therefrom, means for performing frequency domain analysis on the one or more interfering signals to yield frequency domain characterizations therefrom, means for identifying unacceptable conditions on the cable by comparing the time domain characterizations and the frequency domain characterizations to corresponding references.

### BRIEF DESCRIPTION OF THE DRAWINGS

The invention is herein described, by way of example only, with reference to the accompanying drawings, wherein:

FIG. 1 is a block diagram illustrating the typical 1000Base-T noise environment;

FIG. 2 is a block diagram illustrating an example communications transceiver incorporating the noise source characterization scheme of the present invention;

FIG. 3 is a block diagram illustrating the time and frequency domain analysis modules of the noise source characterization module of the present invention;

FIG. 4 is a diagram illustrating the alien NEXT (ANEXT) noise environment;

FIG. 5 is a block diagram illustrating an example implementation of the MSE calculator of the present invention in more detail; and

FIG. 6 is a block diagram illustrating an example implementation of the energy calculator of the present invention in more detail.

### DETAILED DESCRIPTION OF THE INVENTION

### Notation Used Throughout

The following notation is used throughout this document.

| Term | Definition |
|---|---|
| ADC | Analog to Digital Converter |
| AGC | Automatic Gain Control |
| ANEXT | Alien Near-End Crosstalk |
| ASIC | Application Specific Integrated Circuit |
| AWGN | Additive White Gaussian Noise |
| DFE | Decision Feedback Equalizer |
| DSP | Digital Signal Processor |
| ELFEXT | Equal Level Far-End Crosstalk |
| FBE | Feedback Equalizer |
| FEXT | Far-End Crosstalk |
| FFE | Feedforward Equalizer |
| FIFO | First In First Out |
| FIR | Finite Impulse Response |
| FPGA | Field Programmable Gate Array |
| GE | Gigabit Ethernet |
| HDL | Hardware Description Language |
| HPF | High Pass Filter |
| IC | Integrated Circuit |
| IDFT | Inverse Discrete Fourier Transform |
| IEEE | Institute of Electrical and Electronics Engineers |
| IFFT | Inverse Fast Fourier Transform |
| ISI | Intersymbol Interference |
| LMS | Least Mean Square |
| LPF | Low Pass Filter |
| MDELFEXT | Multiple Disturber Equal Level Far-End Crosstalk |
| MSE | Mean Squared Error |
| NEXT | Near-End Crosstalk |
| PLL | Phase Locked Loop |
| PSELFEXT | Power Sum Equal Level Far-End Crosstalk |
| RAM | Random Access Memory |
| RF | Radio Frequency |
| STP | Shielded Twisted Pair |
| UTP | Unshielded Twisted Pair |

### DETAILED DESCRIPTION OF THE INVENTION

The present invention provides a novel mechanism for identifying and characterizing noise sources affecting a communications link, e.g., Gigabit Ethernet, using time and frequency domain analysis techniques. Detected noise sources are characterized and compared to an acceptable envelope mask. If the noise source is out of the permitted envelope mask as defined by the relevant standard, it is reported. The mechanism utilizes both time and frequency domain analysis to detect and characterize noise sources.

To aid in understanding the principles of the present invention, the description of the Ethernet noise characterization mechanism is provided in the context of an Ethernet transceiver circuit that can be realized in an integrated circuit (IC). The noise source characterization mechanism of the present invention has been incorporated in an Ethernet IC adapted to provide 10Base-T, 100Base-T and 1000Base-T communications over a metallic twisted pair channel. Although the invention is described in the context of a gigabit Ethernet PHY communications link, it is appreciated that one skilled in the art can apply the principles of the invention to other communication systems without departing from the scope of the invention. In addition, the noise characterization can be performed utilizing a conventional communications receiver without the need for special measurement equipment. This is achieved by reusing a portion of the functionality present on a typical receiver.

It is appreciated by one skilled in the art that the noise source characterization mechanism of the present invention can be adapted for use with numerous other types of wired communications networks such as coaxial channels, etc. without departing from the scope of the invention.

Note that throughout this document, the term communications device is defined as any apparatus or mechanism adapted to transmit, receive or transmit and receive data through a medium. The term communications transceiver is defined as any apparatus or mechanism adapted to transmit and receive data through a medium. The communications device or communications transceiver may be adapted to communicate over any suitable medium, including wired media such as twisted pair cable or coaxial cable. The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

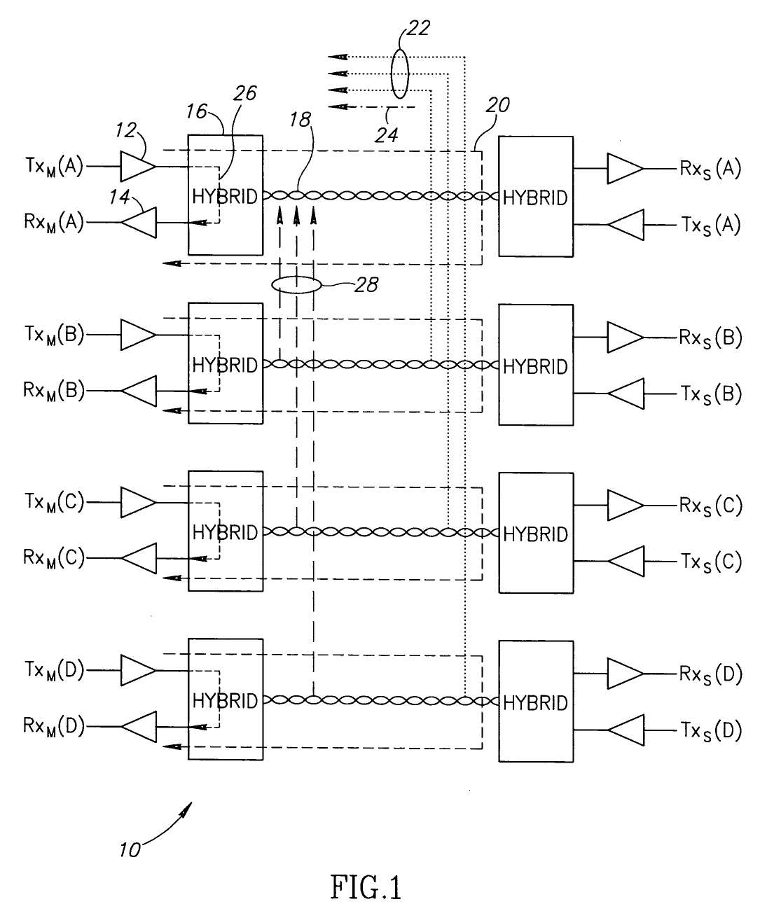

A block diagram illustrating the typical 1000Base-T noise environment is shown in FIG. 1. The environment, generally referenced 10, comprises two transceivers Master (M) and Slave (S), each comprising a plurality of transmitters 12, receivers 14 and hybrid circuits 16. The transceivers are coupled by a plurality of twisted pair cables 18. A gigabit Ethernet communications link is characterized by full duplex transmission over Category 5 and higher cable that may be shielded (STP) or unshielded twisted pair (UTP) cable. The cable comprises four twisted metallic copper pairs wherein all four pairs are used for both transmission and reception.

In operation, each transceiver receives an input data stream from an external data source such as a host or other entity (not shown). The transceiver generates an output symbol stream from the input data stream and transmits the output symbol stream over the communications channel to the transceiver on the other side. The transceivers on either end of a channel are considered link partners. One is designated a master, the other a slave. A link partner can be either active or inactive. An inactive link partner is a transceiver that is not transmitting at the moment. An active link partner is a transceiver that is currently transmitting.

In the receive direction, each transceiver receives a receive signal from the communications channel. The receive signal may comprise an input symbol stream transmitted from the link partner. The transceiver generates and output from this input symbol stream. The receive signal may also comprise a signal representing energy from any number of noise sources, e.g., an echo signal representing the original transmitted signal that has been reflected back towards the transceiver. The transmitted signal may be reflected back due to a channel fault such as an open cable, shorted cable, unmatched load or any irregularities in impedance along the length of the cable. Such irregularities may be caused by broken, bad or loose connectors, damaged cables or other faults.

The Ethernet PHY environment is typically exposed to diverse noise sources. Several of these noise sources are illustrated in FIG. 1, and include: near-end echo 26, far-end echo 20, attenuation 24, near-end crosstalk 28 and far-end crosstalk 22.

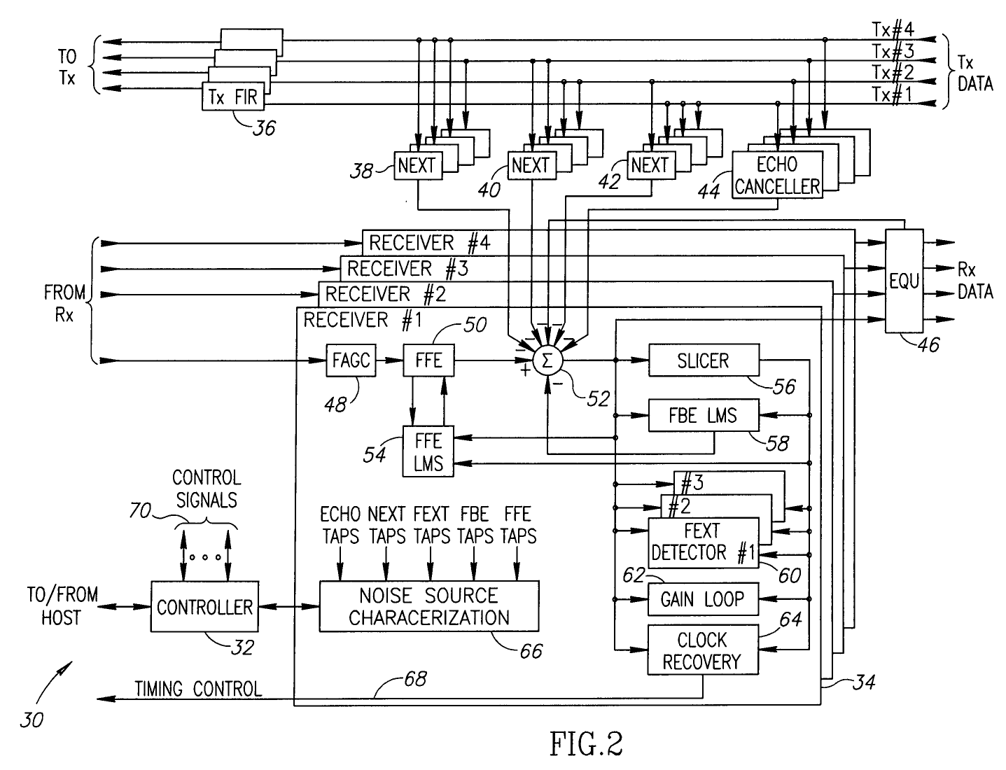

A block diagram illustrating an example communications transceiver incorporating the noise source characterization scheme of the present invention is shown in FIG. 2. The transceiver, generally referenced 30, comprises TX FIR filter blocks 36 (one for each of four twisted pairs), four receiver blocks 34, controller 32, NEXT blocks 38, 400, 42, echo canceller 44 and equalizer 46. Each of the receiver blocks 34 comprises fine automatic gain control (AGC) 48, feed forward equalizer (FFE) 50, least mean squares (LMS) block 54, summer 52, slicer 56, feedback equalizer (FBE) LMS 58, three FEXT detector blocks 60, gain loop 62, clock recovery block 64 and noise source characterization block 66.

In operation, receivers #1, #2, #3 and #4 receive the appropriate NEXT and echo from the NEXT and blocks 38, 40, 42 and echo canceller blocks 44, respectively. For each receiver, corresponding to a twisted pair, the NEXT is calculated from the TX signals for the other three pairs. For example, the NEXT for receiver #1 (i.e. pair #1), is calculated from signals TX #2, TX #3 and TX #4. Similarly, the FEXT is calculated b considering the other three twisted pairs. For example, the FEXT for receiver #1 (i.e. pair #1), considers FEXT from pairs #2, #3 and #4 (via FEXT detect #2 and #3 60).

The clock recovery block generates the timing control signal 68. Controller 32 communicates with a host (not shown) and provides administration, configuration and control to the transceiver via plurality of control signals 70.

The noise source characterization block 66 implements the noise source characterization mechanism of the present invention and is adapted to receive as input echo taps information, NEXT taps information, FEXT taps information, FBE taps information and FFE taps information.

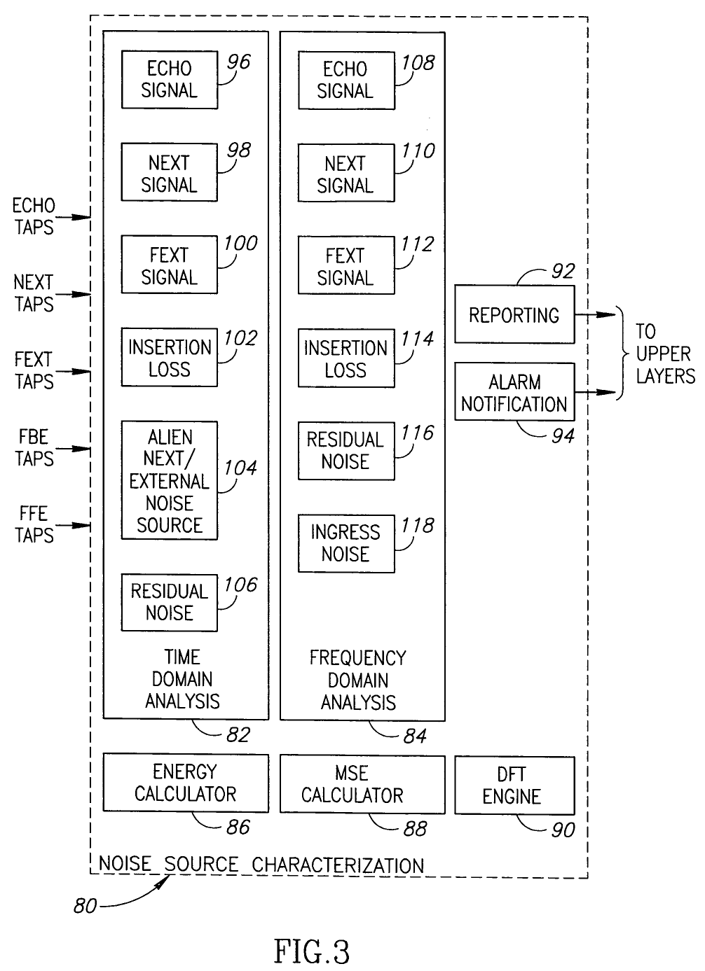

The noise source characterization block will now be described in more detail. A block diagram illustrating the time and frequency domain analysis modules of the noise source characterization module of the present invention is shown in FIG. 3. The noise source characterization block, generally referenced 80, comprises a time domain analysis module 82 and a frequency domain analysis module 84, energy calculator block 86, mean square error (MSE) calculator 88, discrete Fourier transform (DFT) engine 90, reporting module 92 and alarm notification module 94.

The time domain analysis block comprises a plurality of characterization modules for characterizing various different noise sources using time domain techniques. In the example provided herein, time domain noise characterizations include: echo signal 96, NEXT signal 98, FEXT signal 100, insertion loss 102, alien NEXT/external noise source 104 and residual noise 106.

Similarly, the frequency domain analysis block 84 comprises a plurality of characterization modules for characterizing various different noise sources using frequency domain techniques. In the example provided herein, frequency domain noise characterizations include: echo signal 108, NEXT signal 110, FEXT signal 112, insertion loss 114, residual noise 116 and ingress noise 118.

The invention is operative to monitor and analysis several 1000Base-T impairments. Note that these and other impairments may be applicable to other communication link PHY schemes and are not to be limited to gigabit Ethernet. The requirements of the impairments to be monitored are defined by the IEEE 802.3 1000Base-T specification. The requirements presented infra apply to a 100 meter cable at all frequencies from 1 MHz to 100 MHz.

Insertion loss/Attenuation: Insertion loss (denoted by line 24 in FIG. 1) is the intersymbol interference (ISI) introduced to the far side transmitted signal and is compensated by the equalizer in the receiver. The worst case insertion loss is defined by the IEEE 802.3 standard as:
Insertion_Loss(f)<2.1f^{-0.529}+0.4/f dB (1)
where f denotes frequency.

Return loss (echo)/near-end echo rejection: The echo signal (denoted by line 26 in FIG. 1) is the reflection of the transmitted signal unto the receiver path. The echo can be a near-end echo reflection due to the full duplex usage of each pair or a far-end reflection due to unmatched hardware connection components along the cable topology or at the far-side connector. The worst case far-end return loss is defined by the IEEE 802.3 standard as:

$$Return\_Loss ( f ) \{ \begin{matrix}15 & ( 1 \text{-} 20 MHz ) \\ 15 - 10 {log}_{10} ( f / 20 ) & ( 20 \text{-} 100 MHz )\end{matrix} \} dB \qquad ( 2 )$$

where f denotes frequency and where the requirements for CAT5E is modified from 15 dB to 17 dB (i.e. an increase of 2 dB). Note that a high level of near-end echo signal may indicate a printed circuit board fault. Note also that the near-end echo reflection level is implementation specific and may be compensated for by the hybrid analog block 16 (FIG. 1).

Near-end crosstalk (NEXT) and far-end crosstalk (FEXT): NEXT crosstalk (denoted by lines 28 in FIG. 1) and FEXT crosstalk (denoted by line 22 in FIG. 1) are undesired signals that couple between adjacent pairs. The NEXT is noise coupled from near-side adjacent transmitters (i.e. of the other three pairs). FEXT is noise coupled from far-side adjacent transmitters.

The worst case NEXT coupling is defined by the IEEE 802.3 standard as:
NEXT(f)>27.1−16.8 log₁₀(f/100) dB (3)
where f denotes frequency. Note that the standard also defines the following properties:
1. Equal Level FEXT (ELFEXT) is defined as the noise coupled from far-side transmitters to a far-side link partner and can be formulated as
   ELFEXT=FEXT−Insertion_loss (4)
2. Multiple Disturber ELFEXT (MDELFEXT) is defined as the different ELFEXT coupled from each of the three adjacent link partners in accordance with the following masks:

$$MDELFEXT ( f ) = \{ \begin{matrix}17 - 20 {log}_{10} ( f / 100 ) \\ 19.5 - 20 {log}_{10} ( f / 100 ) \\ 23 - 20 {log}_{10} ( f / 100 )\end{matrix} dB \qquad ( 5 )$$

where f denotes frequency and where the sum of the three ELFEXT signals is defined as Power Sum ELFEXT (PSELFEXT) which is limited by:
PSELFEXT(f)>14.4−20 log₁₀(f/100) dB (6)

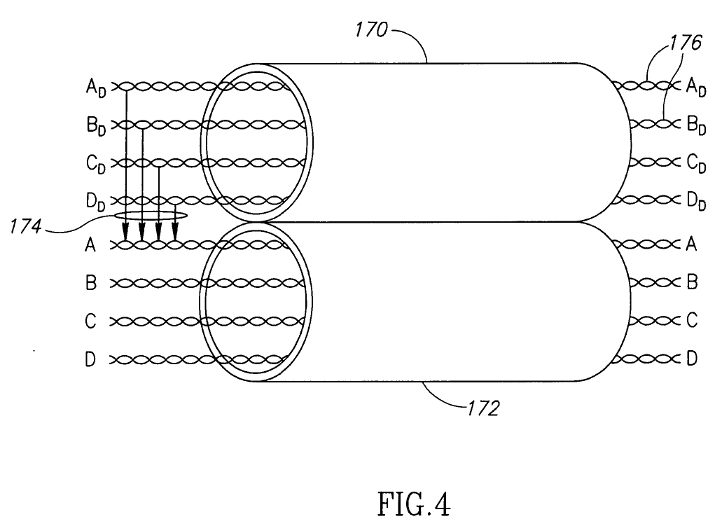

Alien NEXT (ANEXT): A diagram illustrating the alien NEXT (ANEXT) noise environment is shown in FIG. 4. The ANEXT noise (denoted by lines 174) is coupled to the modem receive path associated with the twisted pairs 176 in cable 172 from adjacent twisted pair links in cable 170. Unlike the NEXT noise signals, which are generated from a known transmitted sequence and therefore can be cancelled, the ANEXT noise signal is unknown and is thus much harder to cancel. The IEEE 802.3 standard defines the ANEXT as a 25 mV peak-to-peak signal generated by an attenuated 100Base-TX signal coupled to one of the receiver pairs.

Note that this model for the ANEXT may not be accurate since the ANEXT cannot be separated from the external coupled noise definition. It is assumed, however, that the external noise is composed of AWGN and the colored Alien NEXT. The standard does specify the PSNEXT loss as follows:
PSNEXT_loss(f)<35−15 log₁₀(f/100) dB (7)
where f denotes frequency.

External noise: External noise is defined by the IEEE 802.3 standard as noise coupled from external sources and is bounded at 40 mV peak-to-peak (with 3 dB LPF at 100 MHz).

Note that in accordance with the invention, the requirements for each impairment type described supra can be translated to an energy table for use in time domain analysis, and to a receiver frequency mask for use in frequency domain analysis, taking into consideration the following parameters:
1. Maximum power of the signal entering the link. Note that the desired signal as well as the impairing signal power need to be accounted for.
2. Any spectral characteristic of the signal entering the link and the filtering performed on the transmitter side (e.g., partial response, LPF and HPF of the transmitter).
3. Any filtering performed on the receiver side, up to the point where the impairment is measured (e.g., LPF, HPF, FFE).
4. The length of the cable, as indicated using, for example, time domain reflectometry. Note that an error in estimated length may result in a wrong reference to all other impairment measurements leading to inaccurate indications.
5. The range of coefficients used for the analysis. For example, consider echo coefficients being analyzed from the tenth echo coefficient on. In this case, the hybrid effect should be neglected from the reference requirements.

Tables may be constructed specifying the reference values for the expected energy and frequency mask, for each given impairment type, cable length, transmit power, measurement range and any other transmitter/receiver filtering.

Time domain reflectometry is a well-known technique which can be used to detect cable length and impedance mismatches along the cable. Time domain reflectometry is an efficient tool for identifying cable faults, such as open cable, shorted cable, unmatched loads or any impedance mismatches existing along the cable. Such impedance mismatches may be caused by bad or loose connectors, damaged cables or a variety of other faults.

Using time domain reflectometry, the transceiver generates and transmits a pulse out onto the cable. When the pulse reaches a fault along the cable or end of the cable (i.e. open cable, shorted cable or an mismatched load), a portion of the transmitted pulse energy is reflected back. Using knowledge of the propagation speed along the cable the invention estimates the cable length and/or location of the fault.

A key feature of the present invention is to utilize time domain and frequency domain analysis techniques to characterize cable performance, supportable transmission rate and to determine whether cable performance and specification requirements are being met. In some cases, identifying out of envelope behavior helps in correcting any impairments before the link collapses thereby minimizing the impact on the user.

In the time domain analysis method, the power of the interfering signal is measured and compared to a pre-defined allowed reference limit. The allowed limit used as a reference may be a factor of cable type (CAT5, CAT5E, CAT6, etc.). Alternatively, the filter tap values used in the receive signal processing blocks, e.g., echo canceller, NEXT canceller, FEXT canceller, etc., can be used. In addition, the energy of the actual filtered output generated within the receiver from these processing blocks may be used as well. Note that the invention assumes that the reference limits for the interfering signals are provided as time domain limits. Since many of the permitted limits for the interfering signals are provided in the frequency domain, a conversion must first be performed. One method is to perform an inverse Fourier transform (IFFT or IDFT) (i.e. an analytical approach) on the frequency domain impairment limits to obtain the time domain impairment. This can be performed offline before the transceiver is activated. The equivalent time domain response can be determined and from that the thresholds.

The invention takes advantage of the echo and NEXT canceller and FEXT canceller or detector that are typically already incorporated in gigabit Ethernet transceivers. The cancellers themselves contain information about the noise. One technique is to examine the filter taps (e.g., absolute value, sum of squares of the taps, etc.). Another is to examine the filtered output of the cancellers themselves. An energy calculation is performed and the results are checked to determine whether they are within compliance specified by the standard.

In order to determine whether a cable is within specification or not, cables known to meet the standard are measured and the appropriate canceller/detector filter taps are read once convergence is achieved. This provides a baseline threshold to use to compare further measurements to. A network analyzer can be used to calibrate known good cables. Once the transceiver is activated the converged taps are read and stored for use.

If a tap canceller (may be 40 taps or more) is not available, e.g., for cost or size constraints, a single tap is shared in the time domain to adapt for different locations. The values of each tap generated is stored in a memory (RAM, flash, etc.). Once all taps have been generated, the processing proceeds as if a full blown canceller was used. This technique can be used, for example, to implement a FEXT detector.

A description of the time domain methods used to characterize the power of various interfering signals will now be presented.

Echo signal: An adaptive echo canceller is a well-known technique for canceling echo signals. The adaptive echo canceller used the least mean square (LMS) method or its equivalent. In the case that the receiver does not implement an actual echo canceller, a simple echo detector can be implemented that is operative to estimate the required filter taps as a function of the delay without actually canceling the interference. In either case, the echo filter taps can be used to characterize the echo signal power by calculating the quantity Σecho_taps² as described in more detail infra.

Short-range echo: The short-range echo can be characterized in similar fashion as the general echo signal described supra with the exception that only the first several echo canceller filter taps are used for the power calculation. The short-range echo measurement is useful in detecting printed circuit board faults.

NEXT signal: The NEXT signal can be characterized in similar fashion to the echo signal with the difference being that the NEXT canceller filter taps are used rather than the echo canceller filter taps.

FEXT signal: The FEXT signal can be characterized in similar fashion to the echo signal with the difference being that the FEXT canceller filter taps are used rather than the echo canceller filter taps.

Insertion loss: Insertion loss and ISI interference are usually mitigated using an adaptive equalizer. The equalizer may comprise a feed forward equalizer (FFE) or feedback equalizer (FBE). In the case of an FBE, the FBE taps are used in the same way the echo canceller filter taps are used to characterize the power of post-cursor ISI interference detected and cancelled.

Alien NEXT and external noise: Alien NEXT and external noise sources are characterized in the time domain by calculating incoming energy (such as at the analog to digital converter) when no near-end and far-end link activity is present. This can be achieved by disabling the local transmitter and the transmitter in the link partner. The latter is more difficult but can be done via a special protocol or other control means. Alternatively, the local transceiver can force a reset or other function that guarantees that both link partners will not be active.

Residual noise: the residual noise indicates the total noise that remains after all noise cancellation techniques have been applied (including equalization, crosstalk cancellation, echo cancellation, internal noise caused by the receiver, etc.). The residual noise is expected to reach a certain value, which is a function of the design of the particular transmitter and cable that comply with the specification. Note that the residual noise is a function of cable length. The host or other entity compares the residual noise to this expected value and can also compare the residual noise values from each of the four pairs to each other. Note that the time and frequency domain methods of the present invention may be performed on-chip or off-chip depending on the particular implementation.

In frequency domain analysis, the spectrum of the interfering source is calculated and compared to a pre-defined reference limit. The allowed limit may be a factor of the specific cable type (i.e. CAT5, CAT5E, CAT6, etc.). When compared to the time domain analysis, the frequency domain analysis techniques are more intuitive for certain kinds of Ethernet noise sources. This is because many of the limits on the interfering signals are specified in the frequency domain. The frequency domain analysis is operative to perform a discrete Fourier transform (DFT) or other equivalent time to frequency domain transform.

The frequency domain analysis can be divided into (1) global irregularities that are compared to a fixed spectral mask and (2) local irregularities that are compared to a moving average of the spectrum of the signal or filter (e.g., ingress noise and spectral notch identification). In addition, local irregularities can be compared to “polynomial fit” derived mask. The frequency domain analysis is performed using a DFT engine 90 (FIG. 3). The output of the measurement is a good/bad/natural indication. Preferably, deviations from the spectral mask are maintained on a list, with one entry for each lobe. Each entry comprises the following information: peak frequency, width of the lobe, peak deviation from the moving average or spectral mask. Note that the peak is determined as the largest sample within a pre-defined configurable neighborhood.

A description of the methods used to perform frequency domain characterize analysis for the various interfering signals will now be presented.

Echo signal: The echo signal is characterized by performing a DFT on the echo canceller filter taps or on the actual filtered output of the echo canceller. Note that after the initial startup period, the echo canceller taps should be substantially static since the cable and wires typically do not change much with time once installed and operating.

NEXT signal: The NEXT signal is characterized by performing a DFT on the NEXT canceller filter taps or on the actual filtered output of the NEXT canceller.

FEXT signal: The FEXT signal is characterized by performing a DFT on the FEXT canceller filter taps or on the actual filtered output of the FEXT canceller.

Insertion loss: The insertion loss is characterized by performing a DFT on the equalizer taps, the output of the analog to digital converter (ADC) or on actual filtered output of the FBE. The insertion loss output also contain the total energy that deviates from the spectral mask (normalized according to the DFT length) and the DFT variance with respect to its moving average.

Residual noise: As described supra, the residual noise indicates the total noise that remains after all noise cancellation techniques haven been applied. A DFT is performed on this signal which reveals frequency domain characterization of any residual impairments.

Ingress noise and spectral notches identification: The results of a DFI on the output of the ADC or on the input to the slicer is used to search for a spectral notch in the channel or to search for narrowband ingress noise. The search mode is characterized by the frequency resolution as well as the required notch or ingress bandwidth.

As discussed supra, the time domain analysis performs either energy detection of either time domain signals or filter coefficients. In accordance with the invention, the time domain analysis can be performed (1) using a mean square error (MSE) calculator 88 (FIG. 3) when applied to signals or (2) using an energy calculator 86 (FIG. 3) when applied to filter coefficients. The output of this measurement is the energy measurement itself and a good/bad/natural indication relative to a pre-defined table in accordance with the given cable length.

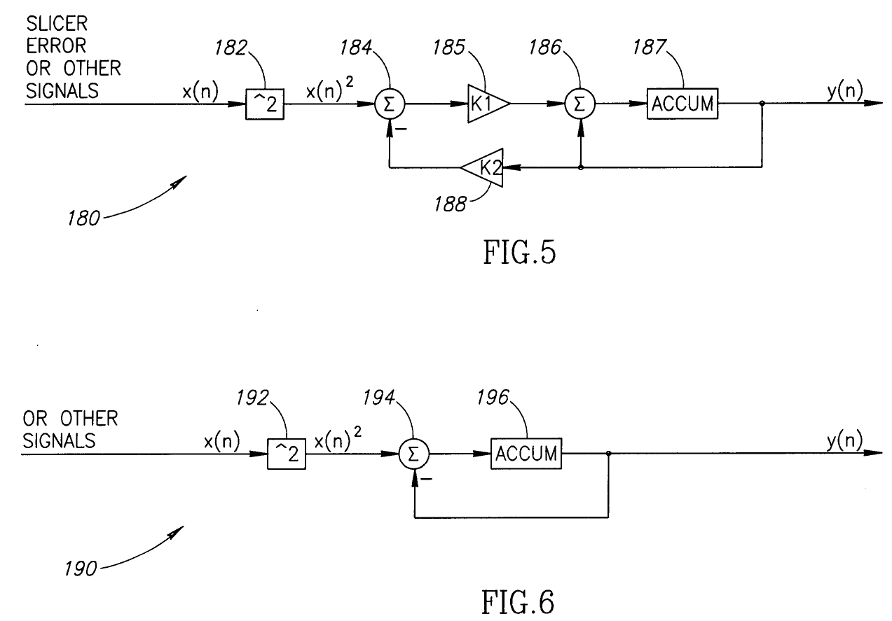

A block diagram illustrating an example implementation of the MSE calculator of the present invention in more detail is shown in FIG. 5. The MSE calculator, generally referenced 180, comprises a squarer 182, summers 184, 186, step gain blocks K1 185 and K2 188, and accumulator 187. The MSE calculator preferably supports input signals from the ADC, DC remover, slicer, echo canceller, NEXT canceller, FFE and DFE (see FIG. 2).

The energy calculator is operative to measure the total energy of a finite set of filter elements. The energy calculator is adapted to handle the echo canceller coefficients, FFE and DFE coefficients, the NEXT canceller coefficients and FEXT detector (or canceller) coefficients. In addition, the energy calculation comprises a control for specifying the range of coefficients to be included in the sum. For example, this permits the exclusion of the first several echo canceller coefficients.

A block diagram illustrating an example implementation of the energy calculator of the present invention in more detail is shown in FIG. 6. The energy calculator, generally referenced 190, comprises a squarer 192, summer 194 and accumulator 196. The energy calculator can be implemented separately or as a layer over the MSE calculator by setting K1=1 and K2=0, and by controlling the locations and length of symbols entering the calculator.

Depending on the particular implementation, measurements provided by the present invention may be valid up to a certain frequency range (e.g., 50-60 MHz) due to the use of an LPF. If the frequency range available is insufficient the LPF in the transmitter and receiver must be bypassed. Alternatively, measurements may be performed at a higher sampling rate using periodic data and different sampling phases. The example transceiver described herein is operative to 125 MHz. The frequency boundary limits are defined, however, to 200 MHz. Thus, the frequency domain analysis is limited in this example implementation to −62.5 MHz to +62.5 MHz.

To increase the resolution, a phase multiplexer is used. The PLL clock circuitry is operative to generate multiple (e.g., 64) phases of the 125 MHz clock. The analog input signal is sampled using one of the 64 phases of the 125 MHz clock. For each of the four twisted pair lines, one of the 64 clock phases is chosen for the sampling rate. A FIFO is used to align and compensate the digitized samples for skew since all four ADCs operate on their own sampling clock with each suffering from their own skew.

In operation, a first clock phase is selected and samples are taken and the filter tap data is extracted. Then, a second clock phase is selected and additional samples are taken and the filter tap data is extracted. This process continues through all 64 clock phases after which results in a frequency response with much higher resolution. Applying this technique to a tap length of 184 with the taps spaced 8 ns from each other, results in an effective tap length of 184×64 taps spaced 125 ps from each other. This permits calculating a DFT having frequency components higher than 62.5 MHz Thus, using the time mechanisms built into the transceiver, i.e. sampling the data at different time locations within the symbol boundaries, any desired resolution can be obtained by providing the appropriate clock phases. This permits analyzing the cable measurement against all relevant frequency boundary limits defined by the standard.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of characterizing communications cable impairments, said method comprising the steps of:
receiving one or more interfering signals over said cable;
for each interfering signal, processing the interfering signal to yield a characterization therefrom; and
identifying unacceptable conditions on said cable by comparing said characterization to a reference.

2. The method according to claim 1, wherein said step of processing comprises performing time domain analysis on said interfering signal.

3. The method according to claim 1, wherein said step of processing comprises measuring the power of said interfering signal.

4. The method according to claim 1, wherein said step of processing comprises calculating the energy of a filtered output signal.

5. The method according to claim 1, wherein said step of processing comprises characterizing echo signal power utilizing echo filter taps.

6. The method according to claim 1, wherein said step of processing comprises characterizing short range echo power utilizing initial echo canceller filter taps.

7. The method according to claim 1, wherein said step of processing comprises characterizing near end crosstalk (NEXT) utilizing NEXT canceller filter taps.

8. The method according to claim 1, wherein said step of processing comprises characterizing far end crosstalk (FEXT) utilizing FEXT canceller filter taps.

9. The method according to claim 1, wherein said step of processing comprises characterizing insertion loss utilizing feedback equalizer (FBE) taps.

10. The method according to claim 1, wherein said step of processing comprises characterizing alien near end crosstalk (alien NEXT) by calculating received energy in the substantially absence of near-end and far-end link activity.

11. The method according to claim 1, wherein said step of processing comprises characterizing residual noise by comparing the noise remaining after noise cancellation to an expected value.

12. The method according to claim 1, wherein said step of processing comprises performing frequency domain analysis on said interfering signal.

13. The method according to claim 1, wherein said step of processing comprises characterizing echo signal power by performing a discrete frequency transform (DFT) on echo canceller taps.

14. The method according to claim 1, wherein said step of processing comprises characterizing near end crosstalk (NEXT) by performing a discrete frequency transform (DFT) on NEXT canceller taps.

15. The method according to claim 1, wherein said step of processing comprises characterizing far end crosstalk (FEXT) by performing a discrete frequency transform (DFT) on FEXT canceller taps.

16. The method according to claim 1, wherein said step of processing comprises characterizing insertion loss by performing a discrete frequency transform (DFT) on equalizer taps.

17. The method according to claim 1, wherein said step of processing comprises characterizing residual noise by performing a discrete frequency transform (DFT) on the noise remaining after noise cancellation.

18. The method according to claim 1, wherein said step of processing comprises identifying spectral notches by performing a discrete frequency transform (DFT) on receive signals.

19. An apparatus for characterizing communications cable impairments, comprising:
means for receiving one or more interfering signals over said cable;
means for processing each interfering signal to yield a characterization therefrom; and
means for identifying unacceptable conditions on said cable by comparing said characterization to a reference.

20. A communications transceiver coupled to a communications channel, comprising:
a transmitter coupled to said communications channel;
a receiver coupled to said communications channel;
a noise source characterization module coupled to said transmitter and receiver, said noise
source characterization module for characterizing communications cable impairments, comprising;
means for receiving one or more interfering signals over said cable;
means for processing each interfering signal to yield a characterization therefrom; and
means for identifying unacceptable conditions on said cable by comparing said characterization to a reference.

21. A communications transceiver coupled to a communications channel, comprising:
a transmitter coupled to said communications channel;
a receiver coupled to said communications channel;
a noise source characterization module coupled to said transmitter and receiver, said noise
source characterization module for characterizing communications cable impairments, comprising;
means for receiving one or more interfering signals over said cable;
means for performing time domain analysis on said one or more interfering signals to yield time domain characterizations therefrom;
means for performing frequency domain analysis on said one or more interfering signals to yield frequency domain characterizations therefrom;
means for identifying unacceptable conditions on said cable by comparing said time domain characterizations and said frequency domain characterizations to corresponding references.
